(19) United States
(12) Patent Application Publication
(10) Pub. No.: US 2011/0087500 A1
(43) Pub. Date: Apr. 14, 2011

(54) PROCESSING PATIENT DATA USING A COMPUTER INTERFACE

(76) Inventors: William Jay McCallum, Fort Worth, TX (US); Jack Edward McCallum, Fort Worth, TX (US); Dietrich Allen Block, Carrollton, TX (US)

(21) Appl. No.: 12/577,504

(22) Filed: Oct. 12, 2009

(51) Int. Cl. G06Q 50/00

(52) U.S. Cl. 705/3

(57) ABSTRACT

The present invention relates generally to healthcare, and more specifically to a process for more completely and more accurately identifying and collecting health insurance plan members' medical diagnoses in compliance with the regulations of one or more health insurance payors such as, but not limited to, the United States Centers for Medicare and Medicaid Services' (“CMS”) Medicare Advantage regulations. In particular, the present invention provides a computer interface whereby health insurance companies may ensure that their members are accurately diagnosed and that claims are accurately filed by reviewing existing member medical records to identify additional diagnoses which may have been treated but not specifically identified in claims filed by the members' health care provider.

### FIELD OF THE INVENTION

The present invention relates generally to healthcare, and more specifically to using a computer interface for more completely and more accurately identifying and collecting medical diagnoses for members of a health insurance plan in compliance with the regulations of one or more health insurance payors. In particular, the present invention provides a computer interface to ensure that health insurance plan providers' members are accurately diagnosed and that claims are accurately filed by reviewing existing member medical records to identify additional diagnoses which may have been treated but not specifically identified in claims filed by the members' health care plan provider. Furthermore, the present invention may reduce the number of audit failures suffered by the practitioner of the present invention. Specifically, by improving the accuracy of diagnoses and the resulting claims, payors may identify fewer errors in a given audit of the invention practitioner's submissions to the payor.

### BACKGROUND

The following background of the present invention will discuss generally the operation of the United States Centers for Medicare and Medicaid Services' (“CMS”) Medicare Advantage and how CMS both strives to provide up-to-date health care coverage while promoting quality care for health insurance plan members and accomplishes those goals, in part, by acting as a payor to health insurance plans. However, it should be understood that the discussion of CMS is by way of example only, and that the present invention may be practiced in association with other payor entities.

In the United States, CMS administers plans known as Medicaid and Medicare, and within Medicare, a plan currently known as Medicare Advantage. Medicare Advantage operates as somewhat of a hybrid between a federally-provided health insurance plan known as Medicare Parts A and B, and a private health insurance plan as provided by health insurance plans other than Medicare. Under Medicare Advantage, health insurance plans register eligible individuals as members. CMS, through the Medicare Advantage plan, pays to a health insurance plan provider a dollar amount generally intended to subsidize the costs to the health insurance plan provider expected to be generated by a particular member, given the health conditions present in that member. In order for a health insurance plan provider to provide up-to-date and quality care for its members, CMS recognizes that the health insurance plan provider must be reimbursed for the extra costs associated with the improved care.

The amount paid to a health insurance plan provider by CMS will generally vary based upon a particular member's health conditions recognized in the CMS model in order to sufficiently reimburse the health insurance plan provider for the expenses expected to be incurred in providing health care to the particular member. Thus, CMS provides an incentive to health insurance plan providers to not only improve the care of their members, but also to insure members who would be otherwise uninsurable due to their health. In particular, as some health insurance plan providers may take the position that enrolling a member with a profile indicating some level of ill health may not be a sound financial decision given the expected costs to care for that member, CMS essentially makes such a member insurable by allocating to the health insurance plan provider some known level of reimbursement for both enrolling a member in poor health and improving the quality of care received by that member.

In treating members, health care providers generally will provide care based on a particular diagnosis. Ideally, these diagnoses are processed and are submitted by a health insurance plan provider to a payor such as CMS, which then reimburses the health insurance plan provider based on the diagnosis. A health insurance plan provider may derive a set of standardized codes which represent the health conditions present in each member. Such codes are thereafter recognized by one or more insurance payors, such as, but not limited to, CMS, and for other purposes related, but not restricted, to management of risk, adjusted payments and patient care. This set of standardized codes, when received by an insurance payor, may then be used by the payor to determine appropriate payment rates to be paid as reimbursement to the health insurance plan provider for providing health insurance to the member represented by the set of standardized codes.

A health insurance plan provider may use an adjudication computer system to receive patient data for large numbers of members of its health insurance plan from numerous health care providers, determine the standardized codes, and submit the standardized codes as claims to a payor such as CMS. However, for a variety of reasons, not all member diagnoses are effectively processed through the adjudication computer system and on to CMS. For example, because a health care provider is generally reimbursed based on treatments provided, rather than diagnoses, a health care provider may note a diagnosis on a member's chart, but because the diagnosis is not essential to the health care providers' reimbursement, not convey the diagnosis to the health insurance plan provider for entry into the adjudication system computer.

Furthermore, in some situations health insurance plan payors, such as CMS, may impose stringent requirements on the type and sufficiency of documentation used to support submission of a standardized code. For example, the payors may require that each and every page, front and back, of a member's medical chart be signed, with credentials, and dated by the treating health care provider. Failure to sign and date the chart pages or even to append the credential “M.D.” to the provider's name, may render the chart pages insufficient documentation to support submission of a standardized code to a payor.

Additionally, not all health care providers may render a diagnosis for the purposes of certain payor guidelines. For example, CMS does not accept standardized codes based on diagnoses rendered by diagnostic radiologists. Thus, if an adjudication system computer attempts to submit a set of standardized codes to CMS based on a diagnosis made by a diagnostic radiologist, the submission could be rejected resulting in a financial penalty to the health insurance plan provider.

Finally, simple errors in coding, and the fact that members may switch health care providers, taking their records with them in the process, may also contribute to disconnects between the diagnoses made by a health care provider and the actual set of standardized codes submitted by an adjudication computer system to a payor.

Compounding the problems just described, health insurance plan providers, in order to be reimbursed under the diagnosis related risk adjustment methodology, are required to annually submit standardized codes based on all member diagnoses to CMS. However, in the case of chronic conditions, there may be no clinically relevant reason for a health care provider to annually record that a member has such a condition. By way of example, if a diabetic member has had an amputation, this condition is persistent and recognized as having the potential to incur an expense. The condition is, therefore, assigned a reimbursement value and a standardized code under the CMS model, but may not cause significant health issues from year-to-year. For this reason, a health insurance plan provider may properly submit a standardized code based on this amputee diagnosis in a given year and be reimbursed from CMS accordingly. However, through error or oversight, or simply because the health care provider has no reason to note the diagnosis in a given year, the amputation diagnosis may not be submitted to the adjudication system computer and may therefore be lost in any year. This situation may prevent the health insurance plan provider from submitting a standardized code based on this amputee diagnosis and recovering a reimbursement from CMS to which it is entitled for providing the enhanced care that may become necessary for that member.

### SUMMARY OF THE INVENTION

The present invention enables accurate gathering of health insurance plan members' medical diagnoses to improve periodic, subsequent submissions to one or more health insurance payors, such as CMS. In so doing, the present invention may improve the likelihood that a health insurance plan provider is accurately reimbursed for the added expense of insuring members having the identified diagnoses. The present invention provides a computer interface that accesses patient data in an adjudication system computer to identify and rank health insurance plan members based on a statistical analysis of the probability that those members may have been incorrectly or incompletely diagnosed or that such diagnoses were incorrectly coded or claimed in the past. The present invention collects health insurance plan members' medical records and may perform a review of such records by a staff of medically-trained individuals.

The present invention improves the accuracy and completeness of the diagnosis data which underlies the payor standardized codes. The present invention reviews the suitability of submitted codes vis-à-vis any requirements of the payor. For example, certain payors may accept diagnoses from only certain types of health care professionals; that is, a diagnosis from a primary care physician may be acceptable, where a diagnosis from a radiologist may not. In certain embodiments, the present invention may review some diagnoses to ensure that they have been provided by payor-approved health care providers.

As another example, certain payors may require that certain formalities, such as the presence of a signature and date on each and every page of a member's chart, are met by the health care provider in recording diagnoses. Therefore, in certain embodiments, the present invention may address recurring failures in the preparation of the chart. Returning to the above example, if a particular health care provider is identified as repeatedly or routinely failing to follow the requirements of a particular payor, the present invention may address this issue and increase the likelihood that future records will be acceptable to the payor.

The present invention provides more accurate preparation of the set of standardized codes which represent member health conditions. By improving the accuracy of this standardized code set, the present invention may reduce the number of audit failures suffered by the practitioner of the present invention. Specifically, by improving the accuracy of the set of standardized codes, payors may identify fewer errors in a given audit of the invention practitioner's submissions to the payor. The present invention properly processes data gathered and analyzed so that the proper standardized codes may be submitted to an appropriate payor, for example CMS.

It is an object of the present invention to improve the quality of care for members of health insurance plans by interfacing with an adjudication system computer to completely and accurately identify all medical diagnoses present in such members.

It is an object of the present invention to overcome the problems associated with an adjudication system computer collecting member medical diagnoses and processing the attendant data to accurately prepare and submit the data to an insurance payor.

It is a further object of the present invention to enable an adjudication system computer to create comprehensive medical diagnoses for health insurance plan members.

It is a further object of the present invention to enable an adjudication system computer to generate and process member health data, including medical diagnoses, in a manner which will improve accuracy in member profile submission to insurance payors.

It is a further object of the present invention to interface with an adjudication system computer to identify health insurance plan members whose medical profile, with regard to medical diagnoses, may be incompletely or inaccurately coded such that one or more medical diagnoses have not been noted or communicated to the adjudication system computer and subsequently correct such incomplete or inaccurate coding to ensure accurate creation and submission of member profiles by the adjudication system computer to one or more insurance payors.

It is a further object of the present invention to interface with an adjudication system computer to identify certain health insurance plan members whose past member profiles may be inaccurate or incomplete with regard to medical diagnoses and correct such past member profiles.

It is a further object of the present invention to interface with an adjudication system computer to identify and correct errors in patient data so that patients may receive a better quality of care in the future.

It is a further object of the present invention to interface with an adjudication system computer to identify and correct errors in patient data so that health insurance plan providers may be accurately reimbursed by one or more insurance payors for insuring particular health insurance plan members.

It is a further object of the present invention to integrate member data in an adjudication system computer.

It is a further object of the present invention to interface with an adjudication system computer to apply known payor guidelines, for example, but not limited to, Medicare Advantage Hierarchal Category Condition rules, disease interactions and diagnosis code mappings to a set of member diagnosis data.

It is a further object of the present invention to gather member health data and process such data by medically trained individuals for submission by an adjudication system computer to an insurance payor system, for example, but not limited to, the Medicare Risk Adjustment Processing System.

### BRIEF DESCRIPTION OF THE DRAWINGS

FIG. 1 is a block diagram depicting the system of the present invention.

FIG. 2 is a flowchart depicting the process of the present invention.

### DETAILED DESCRIPTION

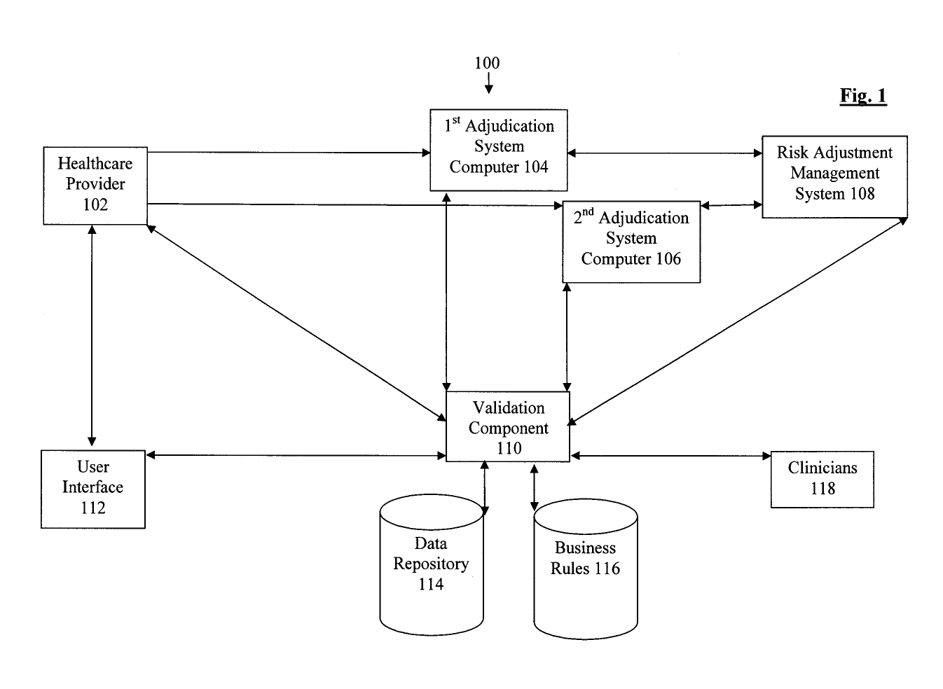

With reference to FIG. 1, a block diagram depicts the system 100 of the present invention. The system includes a healthcare provider 102, a first adjudication system computer 104, a second adjudication system computer 106, and a risk management system 108. The healthcare provider 102 may provide patient data associated with a member of a heath care plan to whichever adjudication system computer 104-106 is associated with the member's health care plan, either directly or indirectly through a clearinghouse. For example, a physician provides a diabetes diagnosis and an insulin prescription for a patient to the first adjudication system computer 104, which is associated with the patient's health care plan. In that case, the adjudication system computer 104 may submit standardized codes based on patient data for expense reimbursement to the risk management system 108. For example, the adjudication system computer 104 for the patient's health care plan submits the diabetes diagnosis for the patient to the risk management system 108. Based on the diabetes diagnosis, the risk adjustment management system 108 authorizes reimbursement for providing health insurance to a patient with a diabetes diagnosis to the patient's health care plan provider.

The system 100 also includes a validation component 110, a user interface 112, a data repository 114, business rules 116, and clinicians 118. The validation component 110 may be stored in a memory and executed in a process to implement the present invention. The validation component 110 may communicate with the healthcare provider 102, the providers of the adjudication system computers 104-106, the provider of the risk management system 108, and/or a user of the system 100 via the user interface 112. The validation component 110 may also communicate directly with the healthcare provider 102, the adjudication system computers 104-106, and the risk management system 108.

Any of the adjudication system computers 104-106 may include the validation component 110. For example, in a “tightly coupled” relationship, the adjudication system computer 104 may have its own dedicated validation component 110 that is configured to receive the patient data based on an access of the patient data in the 1^{st} adjudication system computer 104, but this specific validation component 110 does not communicate with the second adjudication system computer 106 or any other adjudication system computer.

Alternately, the validation component 110 may receive patient data from multiple adjudication system computers 104-106, wherein the multiple adjudication system computers 104-106 are disparate adjudication system computers, such as adjudication system computers provided by competing health insurance plans. For example, in a “loosely coupled” relationship, the validation component 110 may be a general validation component 110 that receives the patient data based on a request for the patient data from both the 1^{st} adjudication system computer 104 and the 2^{nd} adjudication system computer 106.

Whether tightly or loosely coupled, the validation component 110 may store and access patient data for its own use in the data repository 114. Additionally, the validation component 110 may use the business rules 116 to determine which patient data to process. Furthermore, the validation component 110 may prompt the clinicians 118 to assist with processing patient data by reviewing patient data and making determinations about patient data.

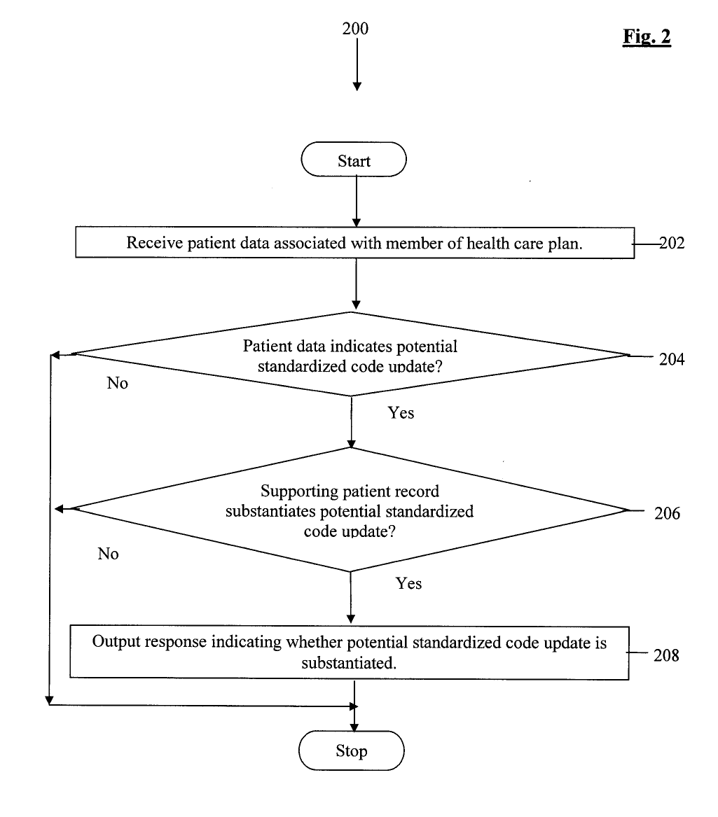

With reference to FIG. 2, a flowchart is depicted of the process 200 of the present invention. The process 200 may be implemented by the system 100, a method of the present invention, or a computer program product of the present invention.

In box 202, patient data associated with a member of a health care plan is received. For example, the validation component 110 receives patient data that specifies an insulin prescription for a patient. In this example, the validation component 110 receives the patient data from the 1^{st} adjudication system computer 104 before the 1^{st} adjudication system computer 104 submits a reimbursement request based on insuring the patient to the risk management system 108.

The validation component 110 may determine whether a business rule of a database of business rules indicates whether to process the patient data. For example, the validation component 110 determines whether the business rules 116 indicate to receive the patient data that includes the insulin prescription. The business rules 116 may identify a set of health insurance plan members who are likely to be incompletely or inaccurately coded in a given year, thereby being preferred candidates for analysis of the member's patient data. Although ideally all members of a health insurance plan would be selected for processing, under some circumstances the practitioner of the present invention may elect not to process all patient data. Furthermore, the selection process may be used for prioritizing the patient data most in need of analysis.

Identifying a set of health insurance plan members who are likely to be incompletely or inaccurately coded may be accomplished by a number of processes such as identifying high-risk or otherwise medically relevant member populations based on, for example, member age, sex, or medical history. Alternatively, or in conjunction with the preceding, the business rules may utilize some or all of these factors which would further refine the selection process. As will be appreciated by those skilled in the art, member characteristics can be used to predict the likelihood of the presence or absence of certain health conditions, or may indicate likelihood that a member may have been inaccurately coded in a given year. In so doing, a practitioner of the present invention may identify a set of members who may be likely to have been incompletely or improperly coded in the past and who, therefore, need to have their patient records analyzed. Such health insurance plan members may also represent opportunities for the health insurance plan provider covering the selected individuals to correct the amount it is reimbursed by its payor, for example, CMS. For example, a practitioner of the present invention may select a group of members known to occupy a specific age bracket; live in a specific geographic area; be employed in a specific industry; or who may otherwise represent instances in which the health insurance plan provider has failed to recoup deserved reimbursements from an insurance payor.

The patient data may include a medical claim that represents a service provided to a patient by a healthcare provider for which direct billing is requested and/or an encounter that represents a service provided to a patient by a healthcare provider for which direct billing is not requested. For example, a physician may submit a direct bill request to the first adjudication system computer 104 for the treatment that resulted in the insulin prescription. An example of an encounter is treatment for which reimbursement has already been capped.

The validation component 110 may associate a pending status with the patient data. For example, the validation component 110 associates a pending status with the patient data that specifies the insulin prescription, such that the 1^{st} adjudication system computer 104 delays processing of the patient data that includes the insulin prescription due to the pending status. Such a delay in processing may result in a delay in seeking reimbursement for providing insurance to the patient for whom the insulin was prescribed. The validation component 110 may delay processing of this patient data until the validation component either determines that no additional standardized codes need to be submitted with the patient data to the risk adjustment management system 108, or until after the validation component 110 creates additional standardized codes to be submitted with the patient data to the risk adjustment management system 108.

In box 204, a determination is made whether patient data indicates a potential standardized code update. For example, the validation component 110 determines that the patient data that includes the insulin prescription indicates a potential standardized code update. The potential standardized code update may represent a potential health condition associated with the member. For example, the potential standardized code update represents a potential diabetes diagnosis because the patient data does not include a diabetes diagnosis although insulin prescriptions are highly correlated with diabetes diagnoses.

The validation component 110 may identify a suspected diagnosis based at least partially on an additional diagnosis associated with an existing diagnosis specified by the patient data. For example, the validation component 110 may identify a specific diabetes type diagnosis based on a current unspecified type of diabetes diagnosis. The suspected diagnosis may be one of multiple suspected diagnoses; and a sequential order for identifying each of the multiple suspected diagnoses may be based at least partially on a corresponding level of diagnosis correlation with the additional diagnosis specified by the patient data. For example, the validation component 110 may produce a list of suspected diagnoses that begins with diabetes-related diagnoses that have the highest correlation with an unspecified type of diabetes diagnosis and ends with diabetes-related diagnoses that have lower correlations with an unspecified type of diabetes diagnosis.

The validation component 110 may compare the patient data to historical patient data, stored in the data repository 114, associated with the member. The historical patient data may include plan membership data, data specifying health care provider eligibility in a health care plan, data specifying a relationship between a member and a health care provider, member claim history data, member encounter history data, healthcare provider data, and risk adjustment authority data. For example, the validation component 110 compares the patient data to historical patient data that specifies whether the patient has been previously diagnosed with diabetes. The validation component 110 may identify a previously submitted standardized code. For example, the validation component 110 identifies a previously submitted standardized code for a diabetes diagnosis.

The validation component 110 may request supporting patient records associated with a member from the health care provider 102. Requesting supporting patient records may include requesting one or more medical charts and/or records from one or more physicians, other health care providers, from pharmacies, from the member's CMS or other payor eligibility records, and/or from CMS or another payor itself in the form of the member's Medicare or other healthcare records. For example, the validation component 110 requests the physician to provide supplemental medical records for the patient for whom the insulin was prescribed. The validation component 110 may receive the supporting patient records. For example, the validation component 110 receives the supplemental medical records from the physician in electronic form.

The validation component 110 may disassociate a pending status with the patient data. For example, the validation component 110 disassociates the pending status with the patient data because patient data that includes both the insulin prescription and a diabetes diagnosis does not indicate a potential standardized code update.

In box 206, a determination is made whether a supporting patient record substantiates a potential standardized code update. For example, the validation component 110 determines that the supporting patient record for the patient with the insulin prescription substantiates a potential diabetes-related standardized code update by prompting a clinician with coding knowledge to analyze the supporting patient record. If the supporting patient record substantiates a potential standardized code update, the method 200 continues to box 208. For example, the supporting patient record includes the currently submitted patient data that identifies a diagnosis of diabetes for which the corresponding standardized code was not submitted. In another example, the supporting patient record includes previously submitted patient data that identifies a diagnosis of diabetes for which the corresponding standardized code was not previously submitted.

Analysis may include a review of the supporting patient records to identify specific treatments performed by a member's physician or other healthcare provider as well as diagnoses recorded within the member's charts. The analysis of the supporting patient records may also incorporate application of standardized rules and guidelines designed to correlate recorded treatments with specific diagnoses. For example, the Medicare system described above promulgates a set of hierarchal rules, disease interactions and diagnosis code mappings which may be used to reliably associate specific treatments with diagnoses.

The validation component 110 may identify a standardized code; determine whether the standardized code was previously submitted; and disassociate the pending status with the patient data in response to a determination that the standardized code was previously submitted. For example, the validation component 110 may identify that the standardized code for a diabetes diagnosis is not included in the current patient data for the patient, determine that the standardized code for diabetes diagnosis was submitted for the patient last month; and disassociate the pending status with the patient data based on last month's submittal of the standardized code for diabetes diagnosis. In this situation, even if a diagnosis is missing from the patient's most recent medical records, the prior recent submission of this missing diagnosis would have already resulted in the proper reimbursement for insuring the diabetic patient during the current year. If the supporting patient record does not substantiate a potential standardized code update, the method 200 terminates.

The validation component 110 may request a health care provider to prospectively evaluate a suspected diagnosis. For example, the validation component 110 may request the patient's physician to prospectively evaluate whether to diagnose the patient with the suspected diagnosis of diabetes.

A set of standardized codes may be generated based on the results of the analysis. Such standardized codes are generally established by the insurance payor and may be used to represent and convey information regarding the member's health condition to the insurance payor so that the insurance payor will reimburse the health insurance plan provider for insuring a member with a set of health conditions and for providing the expected level of care attendant to a member with those conditions.

The set of standardized codes may be prepared for submission and submitted to the insurance payor. Preparation of the set of codes may include a process designed to increase the likelihood that the codes will be accepted by the insurance payor. Thus, these steps may include, by way of example but not limitation, formatting the standardized codes in a manner specified by the insurance payor and ensuring that all required data is present. In a case where the insurance payor is CMS, the formatted codes are generally known as a Risk Adjustment Processing System or RAPS file. A quality assurance step may be performed on the results of the analysis performed to ensure that basic submission requirements are met by the analysis. More specifically, the insurance payor may require specific documentation that meets both CMS and correct coding guidelines. In other words, the insurance payor may require a degree of evidence supporting the addition of a standardized code corresponding to a particular diagnosis, rather than a mere listing of the diagnosis. Thus, a more specific goal is to increase the likelihood that any data gathered during the analysis of the supporting patient records will be ultimately accepted by the insurance payor.

In box 208, a response is output indicating whether a potential standardized code update is substantiated. For example, the validation component 110 outputs a response indicating that the potential diabetes-related standardized code update is substantiated, and updates the patient data by updating a standardized code for the patient's diabetes diagnosis, which is subsequently submitted to the risk adjustment management system 108. The validation component 110 may update the patient data by updating the patient data in the adjudication system computer 104, submitting the updated patient data to the appropriate health care plan provider, or submitting the updated patient data to the risk adjustment management system 108 for reimbursement.

The validation component 110 may disassociate the pending status with the patient data. For example, the validation component 110 disassociates the pending status previously associated with the patient data for the patient with the insulin prescription because the addition of the standardized code for the diabetes diagnosis ensures the proper reimbursement when submitted by the first adjudication system computer 104 to the risk adjustment management system 108.

In some embodiments, the present invention may improve the quality of the submissions to the insurance payor, specifically by increasing the likelihood that such submissions would be found acceptable in a payor audit. For example, the present invention compares the set of prepared codes against an electronic claims file to ensure that the codes are each supported by a claim from an acceptable healthcare provider. Furthermore, some payor guidelines require that certain codes be supported by certain prerequisite codes. Thus, the present invention may test the set of submitted codes to ensure that all prerequisite codes have been included and are properly supported. Additionally, the present invention may also examine the likelihood that the codes are supported by all necessary health care provider/member interactions.

In some embodiments, the present invention may identify certain errors made by health care providers which may render the member's medical charts insufficient to support the submission of standardized codes. By way of example, but not limitation, the present invention may identify that certain healthcare providers fail to routinely sign and date medical charts. Therefore, the present invention may use this data to assist the healthcare provider in properly documenting charts in the future, thereby increasing the likelihood that such charts would be acceptable in a payor audit.

For the purposes of description of the present invention, a health insurance plan provider may be the practitioner of the present invention. However, it should be noted that the practitioner of the present invention may be a third party practicing the present invention for the benefit of a health insurance plan provider. Alternatively, the present invention may be used in a hybrid system, wherein a third party prepares the set of standardized codes, but then the health insurance plan provider submits the set of standardized codes to the insurance payor.

The invention being thus described, it will be obvious that the same may be varied in many ways. Such variations are not to be regarded as a departure from the spirit and scope of the invention and all such modifications as would be obvious to one skilled in the art are intended to be included within the scope of the system, method, or computer program product described.

1. A system for processing patient data, the system comprising:
a processor;
a memory; and
a validation component stored in the memory, wherein said validation component is executed by the processor to:
a) Receive patient data associated with a member of a health care plan via an adjudication system computer prior to a reimbursement request submitted by said adjudication system computer based on said patient data;
b) Determine whether said patient data indicates a potential standardized code update, wherein said potential standardized code update represents a potential health condition associated with said member;
c) Determine whether a supporting patient record substantiates said potential standardized code update in response to a determination that said patient data indicates said potential standardized code update; and
d) Output a response indicating whether said potential standardized code update is substantiated.

2. The system of claim 1 wherein said adjudication system computer comprises said validation component.

3. The system of claim 1 wherein said validation component receives patient data via a plurality of adjudication system computers, wherein said plurality of adjudication system computers comprise said adjudication system computer.

4. The system of claim 3 wherein said plurality of adjudication system computers comprise a plurality of disparate adjudication system computers.

5. The system of claim 1 wherein said validation component receives said patient data via said adjudication system computer based on one of a request for said patient data from said adjudication system computer and an access of said patient data in said adjudication system computer.

6. The system of claim 1 wherein said validation component determines whether said patient data indicates said potential standardized code update based on said validation component determining whether a business rule of a database of business rules indicates whether to process said patient data.

7. The system of claim 1 wherein said validation component determines whether said patient data indicates said potential standardized code update based on a comparison of said patient data to historical patient data associated with said member, wherein said historical patient data is stored in a data repository computer.

8. The system of claim 1 wherein said validation component further:
a) Requests said supporting patient record associated with said member from a health care provider in response to a determination that said patient data indicates said potential standardized code update; and
b) Receives said supporting patient record.

9. The system of claim 1 wherein said patient data comprises at least one of a medical claim that represents a service provided to said member by a healthcare provider for which direct billing is requested and an encounter that represents a service provided to said member by a healthcare provider for which direct billing is unrequested.

10. The system of claim 1 wherein said validation component determines whether said patient data indicates said potential standardized code update based at least partially on identifying a previously submitted standardized code.

11. The system of claim 7 wherein said historical patient data comprises at least one of plan membership data, data specifying health care provider eligibility in said health care plan, data specifying a relationship between said member and a health care provider, member claim history data, member encounter history data, healthcare provider data, and risk adjustment authority data.

12. The system of claim 1 wherein said validation component outputs said response indicating whether said potential standardized code update is substantiated by updating said patient data in response to a determination that said supporting patient record substantiates said potential standardized code update, wherein updating said patient data comprises updating a standardized code for subsequent submission to a risk adjustment management system.

13. The system of claim 12 wherein updating said patient data comprises one of updating said patient data in an adjudication system computer, submitting said updated patient data to a health care plan provider, and submitting said updated patient data to said risk adjustment management system for reimbursement.

14. A method for processing patient data, the method comprising:
a) Receiving patient data associated with a member of a health care plan via an adjudication system computer prior to a reimbursement request submitted by said adjudication system computer based on said patient data;
b) Determining whether said patient data indicates a potential standardized code update, wherein said potential standardized code update represents a potential health condition associated with said member;
c) Determining whether a supporting patient record substantiates said potential standardized code update in response to a determination that said patient data indicates said potential standardized code update; and
d) Outputting a response indicating whether said potential standardized code update is substantiated.

15. The computer implemented method of claim 14 wherein determining whether said patient data indicates said potential standardized code update comprises identifying a suspected diagnosis.

16. The computer implemented method of claim 15 wherein identifying said suspected diagnosis is based at least partially on an additional diagnosis associated with an existing diagnosis specified by said patient data.

17. The computer implemented method of claim 16 wherein said suspected diagnosis is one of a plurality of suspected diagnoses; and a sequential order for identifying each of said plurality of suspected diagnoses is based at least partially on a corresponding level of diagnosis correlation with said additional diagnosis specified by said patient data.

18. The computer implemented method of claim 15 further comprising requesting a health care provider to prospectively evaluate said suspected diagnosis.

19. The computer implemented method of claim 14 wherein determining whether said supporting patient record substantiates said potential standardized code update comprises prompting a clinician with coding knowledge to analyze said supporting patient record to determine whether said supporting patient record substantiates said potential standardized code update.

20. A computer program product for processing patient data, the computer program product comprising:
a computer readable storage medium storing computer executable program code that, when executed by a processor, causes said computer readable storage medium to perform a method comprising:
a) Receiving patient data associated with a member of a health care plan;
b) Associating a pending status with said patient data, wherein said pending status delays processing of said patient data by an adjudication system computer;
c) Determining whether said patient data indicates a potential standardized code update, wherein said potential standardized code update represents a potential health condition associated with said member; and
d) Disassociating said pending status with said patient data in response to determining whether said patient data indicates said potential standardized code update.

21. The computer program product of claim 20 further comprising
a) Determining whether said supporting patient record substantiates said potential standardized code update in response to a determination that said patient data indicates said potential standardized code update; and
b) Outputting a response indicating whether said potential standardized code update is substantiated.

22. The computer program product of claim 21 further comprising:
a) Updating standardized code in response to a determination that said supporting patient record substantiates said potential standardized code update; and
b) Disassociating said pending status with said patient data in response to updating said standardized code.

23. The computer program product of claim 20 wherein disassociating said pending status with said patient data comprises:
a) Identifying a standardized code;
b) Determining whether said standardized code is previously submitted; and
c) Disassociating said pending status with said patient data in response to a determination that said standardized code is previously submitted.
